(19) United States
(12) Patent Application Publication
(10) Pub. No.: US 2017/0009366 A1
(43) Pub. Date: Jan. 12, 2017

(54) EGCG STABILIZED PD NANOPARTICLES, METHOD FOR MAKING, AND ELECTROCHEMICAL CELL

(71) Applicant: The Curators of the University of Missouri, Columbia, MO (US)

(72) Inventors: Kattesh V. Katti, Columbia, MO (US); Orchideh Azizi, Columbia, MO (US); Sagar Gupta, Columbia, MO (US); Kavita K. Katti, Columbia, MO (US); Arie El-Boher, Columbia, MO (US); Robert Duncan, Columbia, MO (US); Graham Hubler, Colubmia, MO (US)

(21) Appl. No.: 15/206,961

(22) Filed: Jul. 11, 2016

Related U.S. Application Data
(60) Provisional application No. 62/190,328, filed on Jul. 9, 2015.

(51) Int. Cl. C25D 13/22; C25D 13/02; C25D 13/04; B05D 7/24

(52) U.S. Cl. CPC C25D 13/22; B05D 7/24; C25D 13/02; C25D 13/04

(57) ABSTRACT

The invention provides stabilized, biocompatible palladium nanoparticles that are stabilized with material from epigallocatechin Gallate (EGCG). The invention also provides electrochemical cells that include EGCG stabilized nanoparticles, and an electrolyte. In preferred embodiments, EGCG palladium nanoparticles are in D₂O or H₂O, and preferred electrolytes are adjusted for conductivity with LiOD and LiOH. The invention also provides for deposition of EGCG palladium nanoparticles. A method of electrolysis of the invention includes applying current to a cell including EGCG palladium nanoparticles. An energy conversion system applies current to cell of the invention and collects heat energy. A net energy gain is measured in experimental energy conversion systems.

### PRIORITY CLAIM AND REFERENCE TO RELATED APPLICATION

This application claims priority under 35 U.S.C. §119 from prior U.S. provisional application Ser. No. 62/190,328, which was filed Jul. 9, 2015.

### FIELD

Fields of the invention include palladium nanoparticles and electrochemical cells. Palladium nanoparticles of the invention are widely applicable in applications including, for example, biomedical applications, sensors, and energy storage, conversion and generation devices and systems.

### BACKGROUND

Palladium nanoparticles have many recognized applications. Example applications include in high capacity hydrogen storage, high efficiency batteries, photosynthetic-energy conversion, catalysis for transformation and synthesis of novel chemical compounds with technological and biomedical applications. See, Horinouchi et al, “Hydrogen Storage Properties of Isocyanide-Stabilized Palladium Nanoparticles” Langmuir, 22 (4), pp 1880-84 (2006); Yu Lei et al, “Amine Synthesis of Porous Carbon Supported Palladium Nanoparticle Catalysts by Atomic Layer Deposition: Application for Rechargeable Lithium-O₂Battery,” Nano Lett., 13 (9), pp 4182-89 (2013); Yi Zhang et al., “Palladium nanoparticles deposited on silanized halloysite nanotubes: synthesis, characterization and enhanced catalytic property,” Scientific Reports 3, Article number: 2948; B. P. Vinayan et al, “Solar light assisted green synthesis of palladium nanoparticle decorated nitrogen doped graphene for hydrogen storage application,” J. Mater. Chem. A, 1, 11192-11199 (2013).

Palladium nanomaterials also find applications as sensors, such as in artificial noses, often referred to as electronic noses, for sensing the presence of toxic gases, bio agents, and explosives. Changes in conductivity of palladium nanoparticles embedded in the sensors enable piezoelectric material changes in frequency that can be measured. Sensors embedded with palladium nanoparticles can also provide fluorescent optical fibers changes in color thus leading to molecular recognition of species, pre-processing of the neural signal and transduction of the signal. Electrochemical sensors, either conductance based or potentiometric (field effect transistor), derived from palladium nanoparticles find applications in the design and development of sophisticated diagnostic devices with applications in defense and biomedical sectors.

Despite widespread interest in and applications for engineered palladium nanoparticles, there remains a need for methods for the reproducible fabrication of well-defined and size tunable palladium nanoparticles. Present methods typically use toxic chemical precursors, and the ability to produce monodisperse palladium nanoparticles remains elusive.

Nanomedicine is an emerging area of medicine that utilizes nanoparticles for the detection and treatment of various diseases and disorders. Nanoparticles are tiny fragments of metals (or non metals) that are 100,000 times smaller than the width of human hair. Nanoparticles typically have different properties than naturally occurring bulk materials. Collateral properties emanate when materials, especially metals, are reduced to dimensions measured in nanometers. Nanoparticles exhibit properties that are unique from their corresponding naturally occurring bulk material.

Nanoparticles within the size range of about 1-50 nanometers have a size that can be correlated to cells, viruses, proteins and antibodies. The size resemblance that such nanoparticles have to living cells and cell components are of great interest to medical research because cells are primary components of all life (humans and animals).

### SUMMARY OF THE INVENTION

The invention provides stabilized, biocompatible palladium nanoparticles that are stabilized with material from epigallocatechin Gallate (EGCG). The invention also provides electrochemical cells that include EGCG stabilized nanoparticles, and an electrolyte. In preferred embodiments, EGCG palladium nanoparticles are in D₂O or H₂O, and preferred electrolytes are adjusted for conductivity with LiOD and LiOH. The invention also provides for deposition of EGCG palladium nanoparticles. A method of electrolysis of the invention includes applying current to a cell including EGCG palladium nanoparticles. An energy conversion system applies current to a cell of the invention and collects heat energy. A net energy gain is measured in experimental energy conversion systems.

### BRIEF DESCRIPTION OF THE DRAWINGS

FIG. 1 is a spectral graph of absorption of EGCG stabilized nanoparticles in H₂O produced in an experiment according to a method of the invention;

FIG. 2 is a spectral graph of absorption of EGCG stabilized nanoparticles in D₂O produced in an experiment according to a method of the invention;

FIG. 3 is a spectral graph of absorption of EGCG stabilized nanoparticles in H₂O produced in a second experiment according to a method of the invention;

FIG. 4 is a spectral graph of absorption of EGCG stabilized nanoparticles in D₂O produced in a second experiment according to a method of the invention;

FIG. 5 is a spectral graph of absorption of EGCG stabilized nanoparticles in D₂O produced in a third experiment according to a method of the invention;

FIG. 6 is a spectral graph of absorption of EGCG stabilized nanoparticles in H₂O produced in a third experiment according to a method of the invention;

FIGS. 7A and 7B are TEM images of different magnification of EGCG stabilized nanoparticles in H₂O produced in an experiment according to a method of the invention;

FIGS. 8A and 8B are TEM images of different magnification of EGCG stabilized nanoparticles in H₂O produced in an experiment according to a method of the invention;

FIG. 9A is a schematic cross-sectional diagram of an experimental electrochemical cell according to an embodiment of the invention that included an isoperibolic calorimeter; FIG. 9B is an image of the anode and cathode “sandwich” assembly from the experimental devices;

FIG. 10A plots input current, FIG. 10B net input power (Pᵢₙₑₜ) and output power (Pₒᵤₜ) and FIG. 10C thermal response power (Pₓ) of an electrolysis experiment in EGCG palladium nanoparticles in D₂O and 0.1M LiOD used to adjust electrolyte conductivity from an experiment (Experiment No. 1039) with an electrochemical cell of the invention;

FIG. 11 is a plot of coefficient of cell performance for an electrolysis experiment as a function of real time sequence of applied different current densities in EGCG palladium nanoparticles in D₂O in the presence of 0.1M LiOD adjusted electrolyte from an experiment with an electrochemical cell of the invention;

FIGS. 12A and 12B are SEM images of an experiment (Experiment No. 1039) that deposited layer of Pd from EGCG palladium nanoparticles in D₂O on Pd substrate in the presence of 0.1M LiOD adjusted electrolyte by direct current density of 6-41 mA/cm² for 30 days in accordance with an embodiment of the invention;

FIG. 13A plots input current, FIG. 13B net input power (Pᵢₙₑₜ) and output power (Pₒᵤₜ) and FIG. 13C thermal response power (Pₓ) of an electrolysis experiment in EGCG (with no nanoparticles) in H₂O and 0.1M LiOH adjusted electrolyte as an electrolyte from an experiment with an electrochemical cell of the invention;

FIG. 14A plots input current, FIG. 14B net input power (Pᵢₙₑₜ) and output power (Pₒᵤₜ) and FIG. 14C thermal response power (Pₓ) of an electrolysis co-deposition experiment (Experiment No 1042) in the presence of EGCG palladium nanoparticles in D₂O and 0.1M LiOD adjusted electrolyte;

FIGS. 14D and 14E plot thermal response energy and COP vs. Time of the electrolysis experiment (Experiment No 1042) in EGCG palladium nanoparticles in D₂O and 0.1M LiOD adjusted electrolyte;

FIG. 15 illustrates thermal response power as a function of applied current for an electrolysis experiment EGCG palladium nanoparticles in D₂O+0.1M LiOD adjusted electrolyte (Experiment No. 1042) and for EGCG in H₂O+0.1M LiOH adjusted electrolyte (Experiment No. 1040);

FIGS. 16A and 16B are SEM images of an experiment (Experiment No. 1042) that deposited layer of Pd from EGCG palladium nanoparticles in D₂O on Pd substrate in the presence of 0.1M LiOD adjusted electrolyte by direct current density of 6-38 mA/cm² for 26 days in accordance with an embodiment of the invention;

FIG. 17A plots input current, FIG. 17B net input power (Pᵢₙₑₜ) and output power (Pₒᵤₜ) and FIG. 17C thermal response power (Pₓ) of an electrolysis co-deposition experiment of 34 days (Experiment No 1056) in the presence of EGCG palladium nanoparticles in D₂O and 0.1M LiOD adjusted electrolyte;

FIGS. 17D and 17E plot thermal response energy and COP vs. Time of the electrolysis experiment (Experiment No 1056) in EGCG palladium nanoparticles in D₂O and 0.1M LiOD adjusted electrolyte;

FIG. 18A plots input current, FIG. 18B net input power (Pᵢₙₑₜ) and output power (Pₒᵤₜ) and FIG. 18C thermal response power (Pₓ) of an electrolysis co-deposition experiment of 41 days (Experiment No 1080) in the presence of EGCG palladium nanoparticles in D₂O and 0.1M LiOD adjusted electrolyte;

FIGS. 18D and 18E plot thermal response energy and COP vs. Time of the electrolysis experiment (Experiment No 1080) in EGCG palladium nanoparticles in D₂O and 0.1M LiOD adjusted electrolyte;

FIG. 19A plots input current, FIG. 19B net input power (Pᵢₙₑₜ) and output power (Pₒᵤₜ) and FIG. 19C thermal response power (Pₓ) of an electrolysis co-deposition experiment of 14 days (Experiment No 1085) in the presence of EGCG palladium nanoparticles in D₂O and 0.1M LiOD adjusted electrolyte;

FIGS. 19D and 19E plot thermal response energy and COP vs. Time of the electrolysis experiment (Experiment No 1085) in EGCG palladium nanoparticles in D₂O and 0.1M LiOD adjusted electrolyte;

FIGS. 20A and 20B schematically illustrate a 2 electrode cell and a 3 electrode cell, respectively

FIGS. 21A and 21B are SEM images of an electrophoretic deposition experiment (Experiment Number 1057) of deposition of a layer of Pd from EGCG palladium nanoparticles in H₂O on Pd substrate in the presence of 0.1M LiOH adjusted electrolyte by direct current of 3 mA/cm² for 20 min;

FIG. 22 is an SEM image of an electrophoretic deposition experiment (Experiment Number 1043) of deposition of a layer of Pd from EGCG palladium nanoparticles in H₂O on Pd substrate in the presence of 0.1M LiOH adjusted electrolyte by direct current of 5 mA/cm² for 15 min; and

FIGS. 23A and 23B are SEM images after 20 days of electrolysis.

### DETAILED DESCRIPTION OF THE PREFERRED EMBODIMENTS

The invention provides stabilized, biocompatible palladium nanoparticles that are stabilized with material from polyphenols- or flavanoids-rich plant material, and specifically with EGCG (epigallocatechin-gallate). EGCG can be from a commercial source (e.g., Sigma Aldrich, St. Louis, Mo., USA), or can be derived from green tea. The palladium nanoparticles of the invention can be fabricated with an environmentally friendly method for making biocompatible stabilized palladium nanoparticles. Fabrication methods of the invention require only palladium salts as precursors. No other man-made chemicals are employed in the overall fabrication process, and there are accordingly no harsh chemicals utilized in the fabrication or harsh byproducts formed during the fabrication. Fabrication processes of the invention are therefore environmentally friendly and biologically benign.

Preferred embodiments provide an environmentally friendly green nanotechnology pathway for the production of palladium nanoparticles. Methods of the invention use EGCG as an electron reservoir and a reduction agent, to reduce palladium salt to corresponding palladium nanoparticles in the absence of any other reduction agent and without any harsh chemicals. A preferred process for forming palladium nanoparticles consists of reacting palladium salt with EGCG. No toxic chemical reduction agents are used, e.g. methods avoid any use of toxic agents such as hydrazine, sodium borohydride etc. A preferred embodiment consists simply of mixing green tea leaves with palladium salt in water. Another preferred embodiment consists of mixing tea leaves with palladium salt in heavy water.

Methods of the invention can produce well-defined and controlled particle size, charge and size distribution pattern. In preferred embodiments, a high basic pH is achieved through mixing with lithium hydroxide (LiOH) and lithium duteroxide (LiOD).

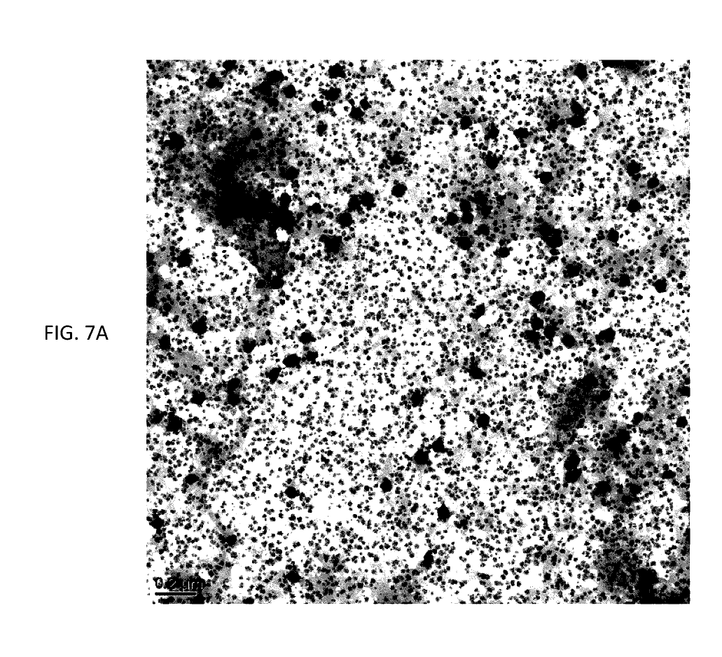

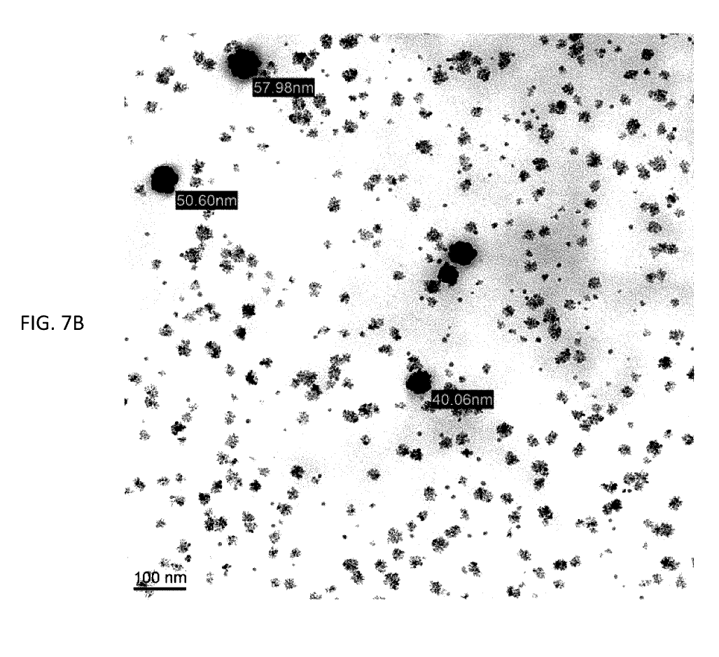

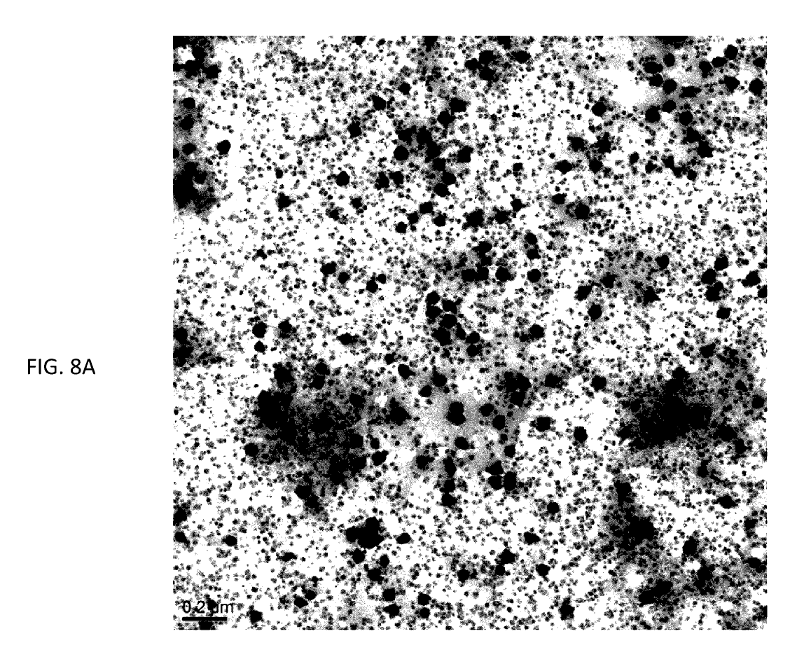

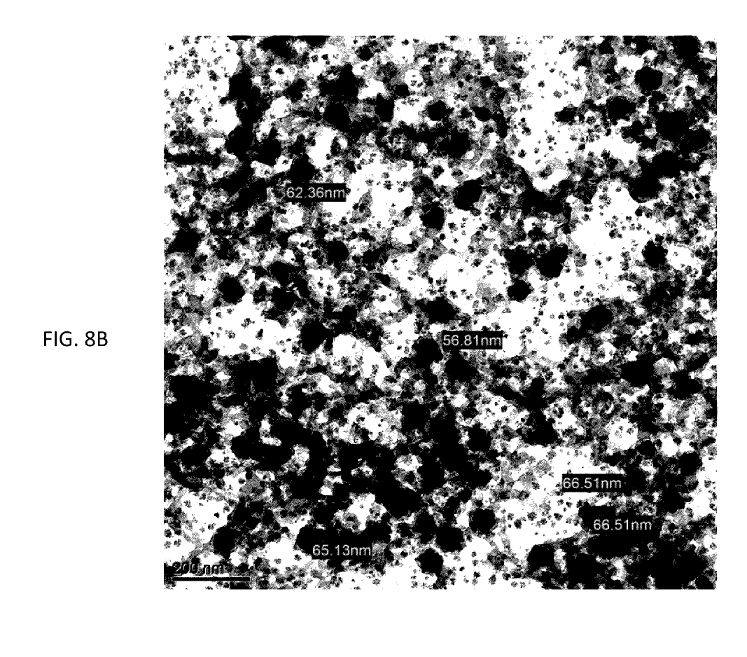

Palladium nanoparticles of the invention can be produced in a preferred size range from 45 nm to 70 nm. EGCG palladium nanoparticles would not settle down and hence could not be washed before imaging. Therefore, the size range was obtained by taking images and observing the particles in TEM as shown in the FIGS. 7B and 8B. EGCG palladium nanoparticles were produced with high negative zeta potential in the range −20 to −50 mV (milli Volts) suggesting excellent stability of these nanomaterials. Preferred embodiments provide palladium nanoparticle suspensions with the concentration of nanoparticles in the range of 1-5 mg/mL.

The invention also provides an electrochemical cell. In the preferred embodiments, the cell includes a suspension of palladium nanoparticles. In other embodiments the nanoparticles are deposited upon a substrate in a liquid cell, which in preferred embodiments can be light water and in other embodiments is heavy water. Electrodes provide energy for electrolysis of the nanoparticles in solution. A thermal response is generated. The invention also provides an assembly and a method and apparatus for measurement of thermal response power (heat), when palladium nanoparticulate suspensions are electrolyzed in heavy and in light water. In preferred embodiments, the palladium nanoparticles are on a metallic substrate, a palladium substrate or a platinum substrate, and are preferably with deposited Single Wall Carbon Nano Tubes (SWCNT). Electrolyzing is conducted in preferred embodiments with Pulsed Current (PC)—Cathodic pulses followed by no current, Pulsed Reversed current (PRC)—that are cathodic pulses followed by anodic pulses, or Highly Modulated Current (HMC).

Preferred embodiments will now be discussed with respect to the drawings. The description includes descriptions of experiments. The drawings include schematic figures that are not to scale, which will be fully understood by skilled artisans with reference to the accompanying description. Features may be exaggerated for purposes of illustration. From the preferred embodiments and experiments, artisans will recognize additional features and broader aspects of the invention.

Example experiments synthesized palladium nanoparticles by reduction with EGCG in both light and heavy water. Measurements were used to characterize the formed particles. Experiments showed that EGCG also plays a unique role not only in the reduction of the metallic salt but also in stabilizing the reduced palladium atoms to form nanoparticles and maintain the monodisperse nature of the suspension to be electrolyzed onto a metallic substrate to generate heat. The B ring of EGCG is the most active and the abundant hydroxyl groups present in the aromatic structure of the polyphenols play a significant role in the reduction of sodium tetracholoropalladate to palladium atoms.

No further treatment is required prior to use of the stabilized, biocompatible palladium nanoparticles produced by the method in biomedical applications. The method produces stabilized, biocompatible palladium nanoparticles that are suitable for use within the body (in vivo) for diagnostic and treatment procedures. Stabilized, biocompatible palladium nanoparticles of the invention are suitable for direct administration into the human body through oral or intravenous routes. The methods produce palladium nanoparticles that require no further purification, that are biocompatible and stable. While the particles are stable as produced, an additional stabilizing agent such as gum Arabic can provide additional stability.

In the following experiments, EGCG was obtained from Sigma Aldrich, St. Louis, Mo., USA, which was mixed with light water or heavy water and palladium salts. Palladium nanoparticles produced by this process do not require any external chemical to stabilize the palladium nanoparticles. The methods provide a robust EGCG coating on palladium nanoparticles, which are stable against agglomerations.

EGCG Palladium Nanoparticle Production in H₂O

1.6 mM solution of sodium tetra choloropalladate Sigma Aldrich (St. Louis, Mo., USA) salt solution was prepared and added to 0.8 mM EGCG Sigma Aldrich (St. Louis, Mo., USA) solution with distilled water as the base at room temperature. The solution was stirred for 24 hours and spectral data was collected every hour till 6 hours and at 24 hours.

EGCG Palladium Nanoparticles in D₂O

1.6 mM solution of sodium tetra choloropalladate salt solution was prepared and added to 0.8 mM EGCG solution with heavy water as the base at room temperature. Care was taken so that the entire reaction took place with minimal light interaction and also was performed in a nitrogen environment to avoid oxygen interaction with the reaction mixture. The solution was stirred for 24 hours and spectral data was collected every hour till 6 hours and at 24 hours.

Measurements and Characterization

The spectroscopic measurements were performed using a Varian Cary 50 UV-Vis spectrophotometer and disposable cuvettes with a volume of 1 mL and a path length of 10 mm. The hydrodynamic diameter and zeta potential were obtained using Zetasizer Nano S90 (Malvern Instruments Ltd. USA). Transmission Electron Microscope (TEM) images were obtained on a JEOL 1400 TEM (JEOL, LTE, Tokyo, Japan). The conductivity readings were obtained using PC700 be, benchtop conductivity meter obtained from Oakton Instruments IL, USA.

Characterization of the EGCG Palladium Nanoparticles

TABLE 1
Average pH and Conductivity measurements EGCG PdNP in H2O
and D2O

| | | Conductivity |
|---|---|---|
| Nanoparticles | pH | (uS) |
| 1X EGCG PdNP H2O EXP 1043 | 2.62 | 1690 |
| and 1057 | | |
| 1X EGCG PdNP D2O EXP 1039, | 2.39 | 1075 |
| 1042, 1056, 1080 and 1085 | | |

TABLE 3
Average zeta Potential and hydrodynamic diameter for EGCG
palladium nanoparticles in H2O and D2O

| | Z potential | Hydrodynamic |
|---|---|---|
| | (Average) | diameter |
| Nanoparticles | [mV] | Mean [nm] |
| 1X EGCG PdNP H2O EXP | −21.5 | 119.13 |
| 1043 and 1057 | | |
| 1X EGCG PdNP D2O EXP | −18 | 107.46 |
| 1039, 1042, 1056, 1080 and | | |
| 1085 | | |

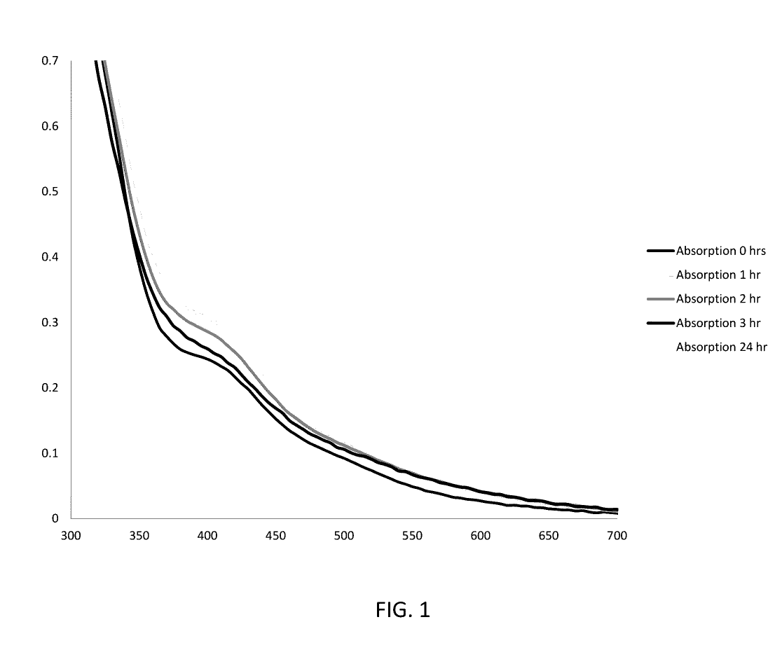

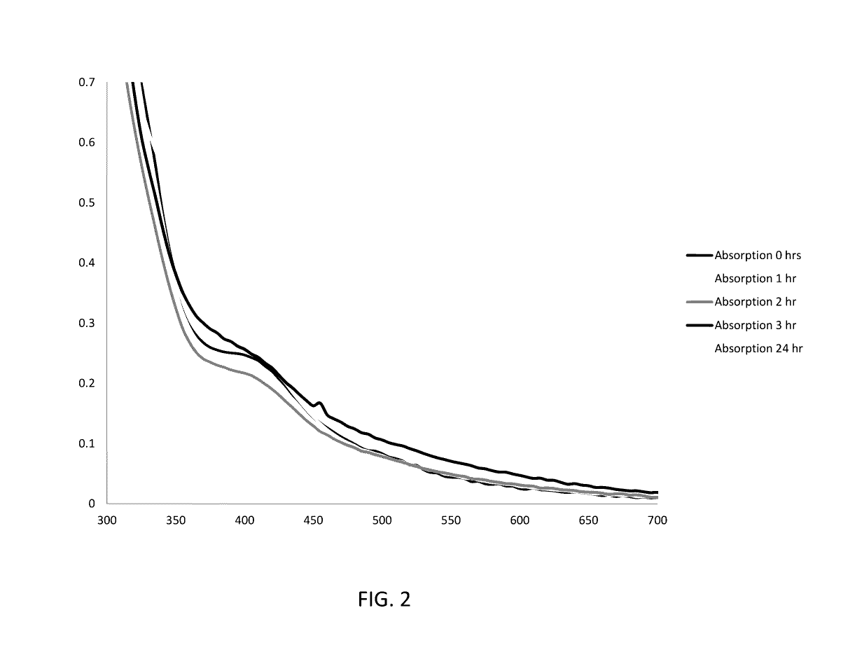

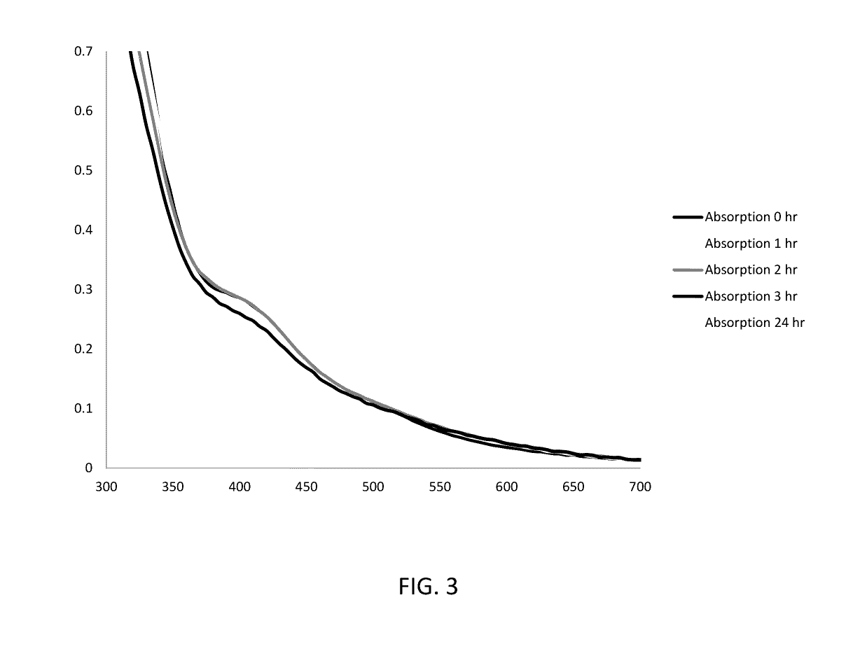

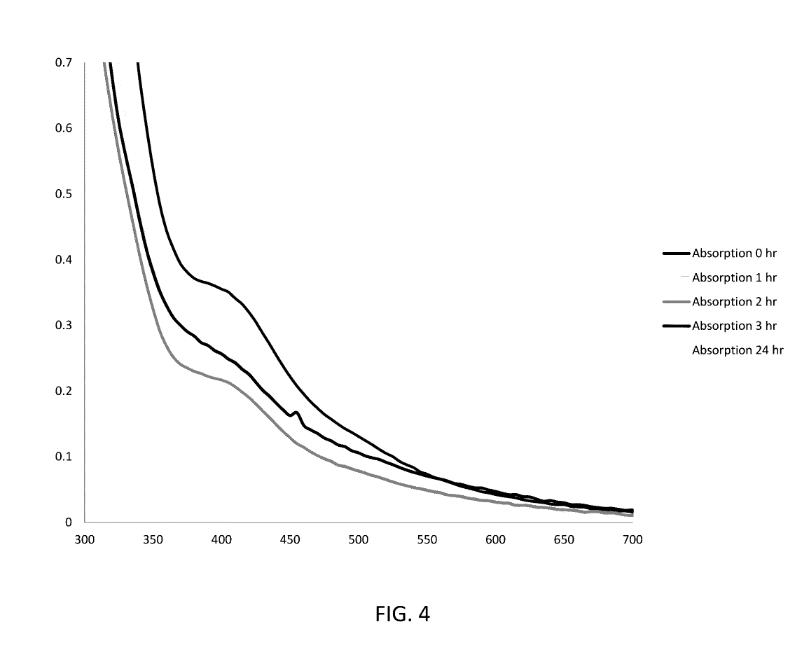

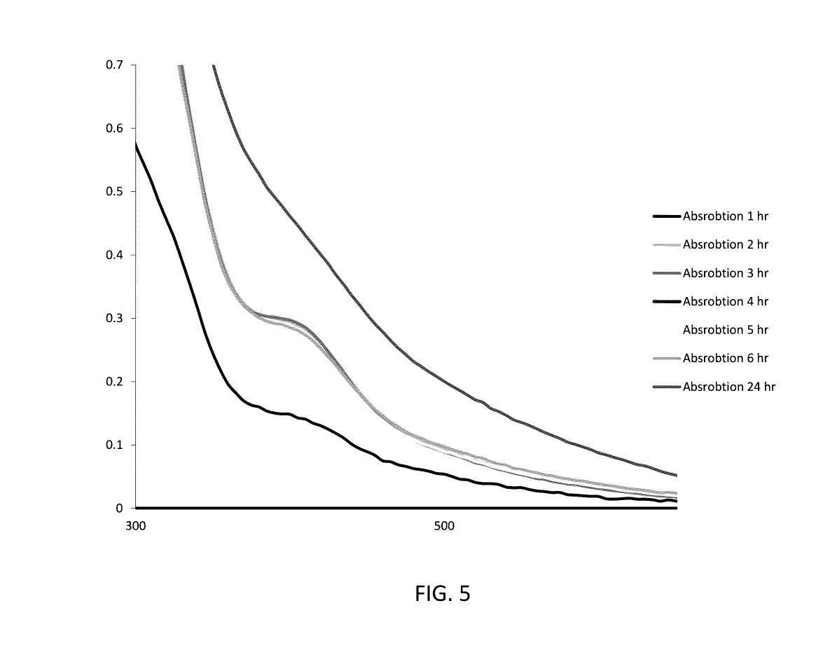

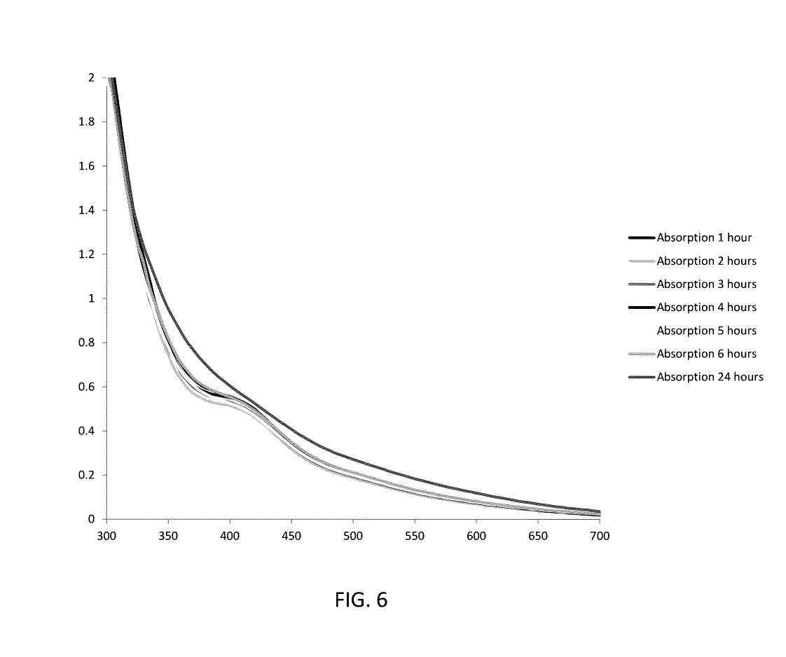

FIGS. 1-6 show the spectra of EGCG palladium nanoparticles for a number of experiments. These experiments show that the free palladium that was in the mixture produced a peak at 420 nm. However, observations of the spectra over different time periods show the amplitude of the peak at 420 nm to decrease. Complete absence of the peak after 24 hours further indicates the reduction of free palladium in the presence of EGCG to form palladium nanoparticles.

The TEM images of FIGS. 7A-7B provide size information about EGCG palladium nanoparticles. As seen in FIG. 7B, the particle sizes for Experiment No 1043 & 1057 were in the range of 40-60 nm (identified particles in FIG. 7B include 40.06, 50.60 and 57.98 nm) The TEM images of FIGS. 8A-8B provide size information about EGCG palladium nanoparticles. As seen in FIG. 8B, the particle sizes for Experiment No 1039, 1042, 1056, 1080 and 1085 were in the range of 58-67 nm (identified particles in FIG. 8B include 56.81, 62.36, 65.13 and 62.36 nm).

Electrochemical Cell, Energy Conversion, Electrolysis & Co-Deposition

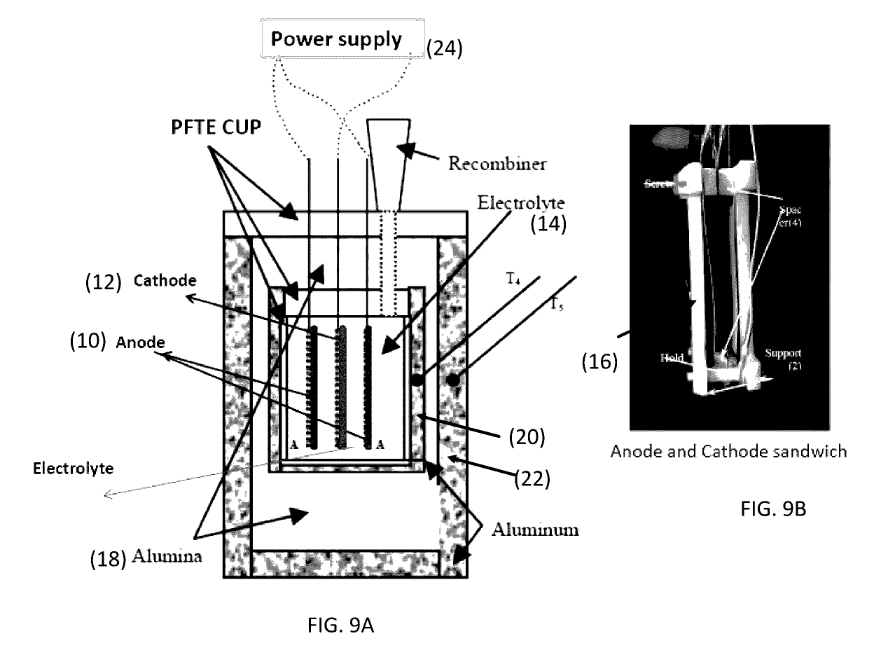

An electrochemical cell was also constructed in an experiment. The cell is shown in FIGS. 9A and 9B. Electrolysis experiments demonstrating energy conversion were conducted by applying current to the cell containing electrolyte and the EGCG palladium nanoparticles. The experiments deposited Pd nanoparticles on a Pd foil as a substrate with Hydrogen/Deuterium Co-deposition. Electrolyte was adjusted for conductivity using LiOH and LiOD. The cell of FIG. 9A includes anodes 10 on either side of a cathode 12, being separated by electrolyte 14, which included the solution of EGCG palladium nanoparticles. FIG. 9B shows details of the anode and cathode “sandwich”, with spacing maintained and set by a dielectric support 16. Alumina 18 served as a barrier to prevent direct physical and thermal contact between an inner container 20 between an outer container 22 and allow measurement of generated heat. A power supply 24 provided power to the electrodes 10, 12.

The experimental cell of FIGS. 9A-9B included the cell and a calorimeter. In the experiment, two platinum anodes of dimension (20 mm×80 mm×100 μm thick) sandwich a palladium cathode (typically 7 mm×80 mm×50 μm thick) FIG. 9B. This three-electrode structure is positioned at the center of a 4.9-cm dia. by 18.5 cm tall cylindrical PTFE cup that comprises the electrochemical cell outer boundary. The electrochemical cell contains two concentric aluminum cylinders with alumina thermal insulation in between the cylinders. In the experiments, the cell was immersed in a constant temperature water bath set at about 15° C. The experimental cell had an external recombiner that collects elecctrolytically generated O₂ and D₂ bubble from the electrolyte and combined it back into D₂O. Output power from the cell has been calculated based on the temperature difference between inner wall temperature T₄ and outer wall temperature T₅ multiplied by the overall heat transfer coefficient (k).

Power output: Pₒᵤₜ=k*[T₄−T₅]

Electrolyte

EGCG palladium nanoparticles: Palladium nanoparticle (PdNP) suspension in (2R,3R)-5,7-dihydroxy-2-(3,4,5-trihydroxyphenyl)-3,4-dihydro-2H-1-benzopyran-3-yl 3,4,5-trihydroxybenzoate (EGCG) was used as an electrolyte. Conductivity was adjusted by adding LiOH/LiOD;

Output Power Calculations

Output power; Pₒᵤₜ has been measured using the temperature difference between inner aluminum cylindrical wall and outer aluminum cylindrical wall temperature, T₄ and T₅ respectively.

Power output: Pₒᵤₜ=k*[T₄−T₅]

Where k is the overall heat coefficient

Input Power and Net Input Power Calculations

In thermodynamically open (although physically partially closed) cells such as the electrochemical cell presented in FIGS. 9A &9B, the chemical energy of the electrolyzed gases, D₂ or H₂ and O₂, are conveyed out of the cell to be externally recombined and the recombinant liquid returned to the cell. The rate of the return liquid flow is low at the currents currently employed, and the return path is well coupled to the ambient. Thus, the returning fluid contributes to the ambient heat leakage, but the exothermic heat of recombination is deposited largely outside the calorimetric boundary. To account for this endothermic term, the electrolytic input power (Pᵢₙ) is modified as:

P_{In}=IV

P_{Inet}I(V−V_{TN})

Where V_{TN}, the thermo-neutral voltage, is 1.54V for the electrolysis of D₂O and is 1.48V for H₂O, and P_{In}I and V are all functions of time. P_{Inet}; net input power.

EGCG Palladium Nanoparticles in D₂O (EXP 1039)

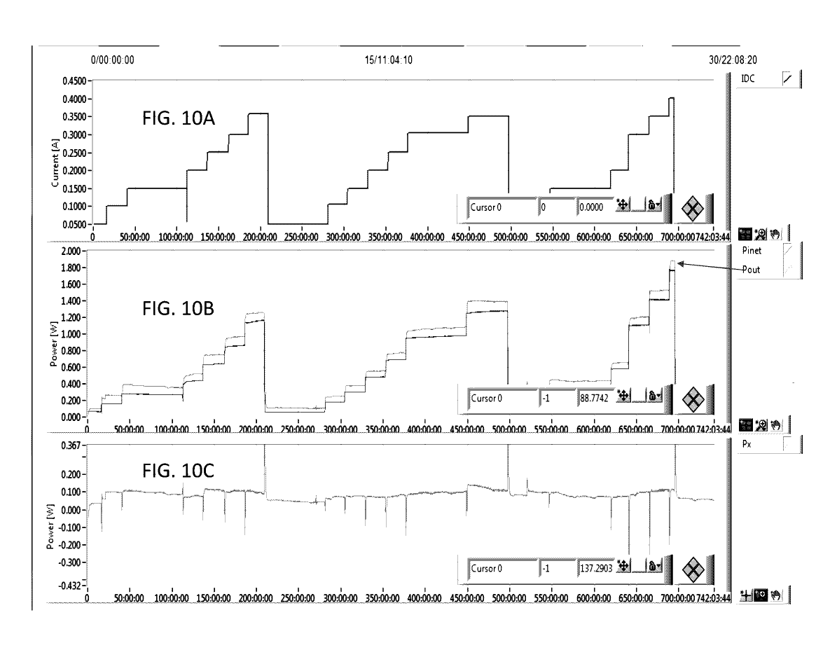

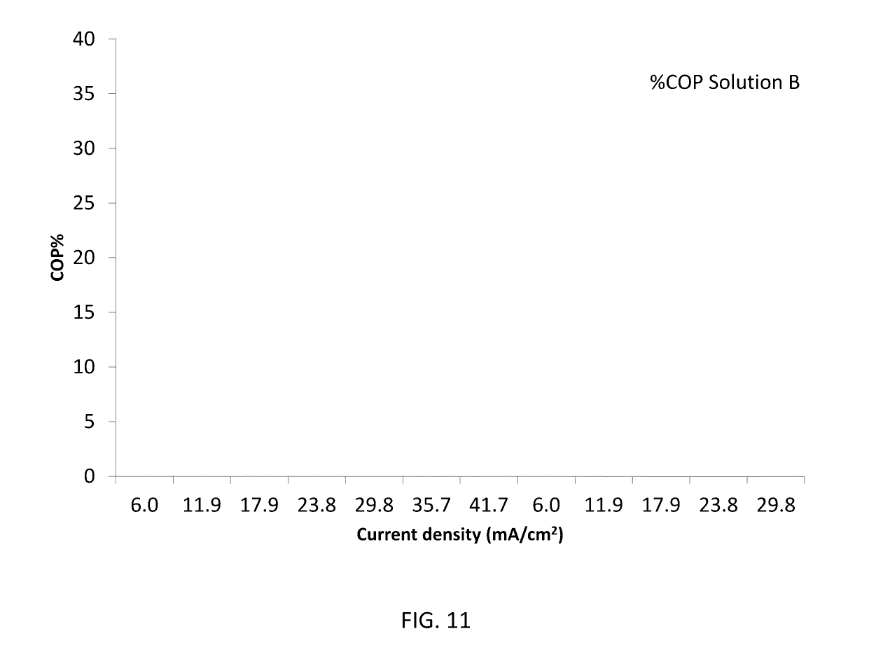

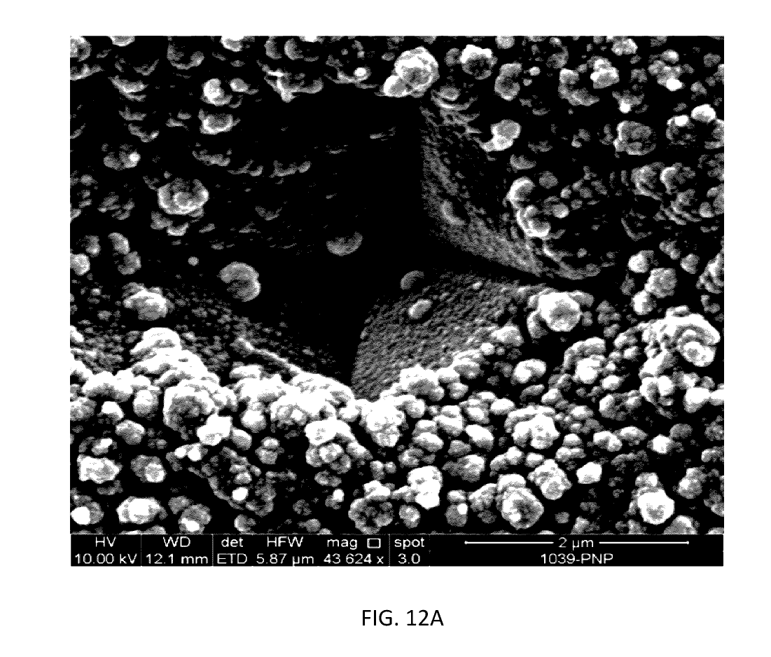

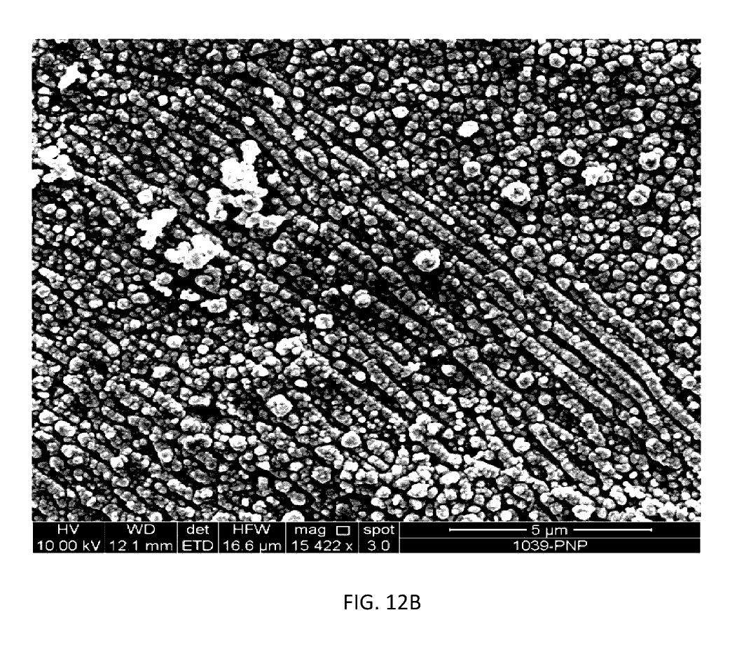

FIGS. 10A-10C are results from a 30 day period of co-deposition experiment in the presence of EGCG palladium nanoparticles in D₂O and 0.1M LiOD (EXP 1039). The results measured ˜0.05-0.1 W of thermal response at an average net input power of 0.15 W to 1.2 W (applied current of ˜50-350 mA). The effect of higher current (input power) on thermal response was investigated by progressively stepping the average input current density to 100, 150, 200, 250, 300 and 350 mA. The thermal response power was almost constant around 0.1 W through the progression of stepped input current density. When the current was dropped back to 50 mA the thermal response dropped back to 0.05 W and then reached 0.1 W at higher applied current. FIG. 11 shows the coefficient of performance (COP) as a function of the real time sequence of applied current densities. The change of current up or down causes immediate change in the input power. The power responds slower due to thermal time response of the cell. The images of FIGS. 12A and 12B show novel (Negative crystal)(Negative crystal mass transfer by evaporation by the surface in 100 lattice structure (pyramid with square base)) and uniform nanostructure Pd deposition with minimum aggregation after continuous deposition of Pd nanoparticles for long period of time 30 days, from EGCG palladium nanoparticles in D₂O in the presence of 0.1M LiOD.

EGCG in H₂O (EXP 1040)

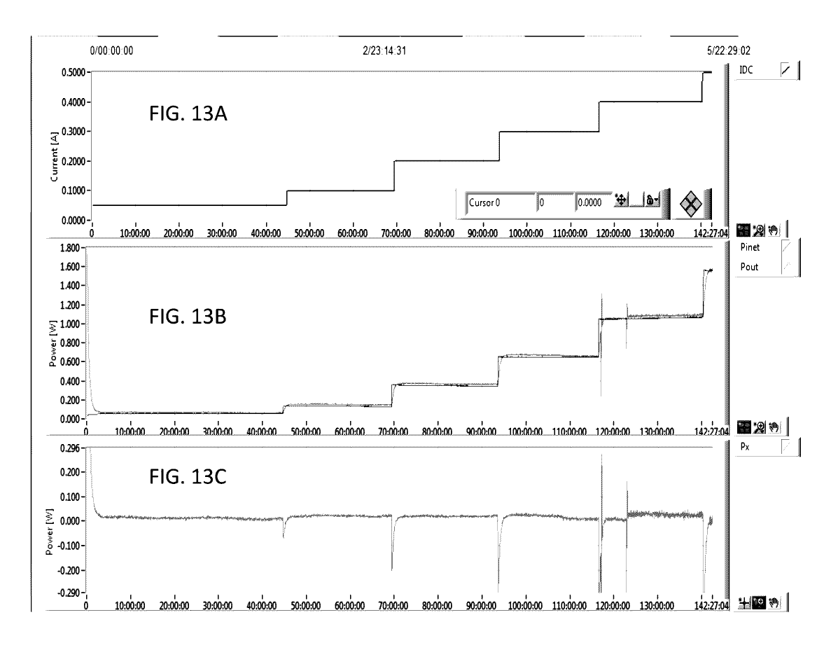

FIGS. 13A-13C are results from an electrolysis experiment in the presence of EGCG and 0.1M LiOH with no nanoparticles. The data show, as a control, that the electrochemical cell didn't show any thermal response during electrolysis experiment in the absence of PdNP (palladium nanoparticles) at various applied current. The co-deposition process of ECGC palladium nanoparticles provides the thermal response.

EGCG Palladium Nanoparticles D₂O and LiOD (EXP 1042)

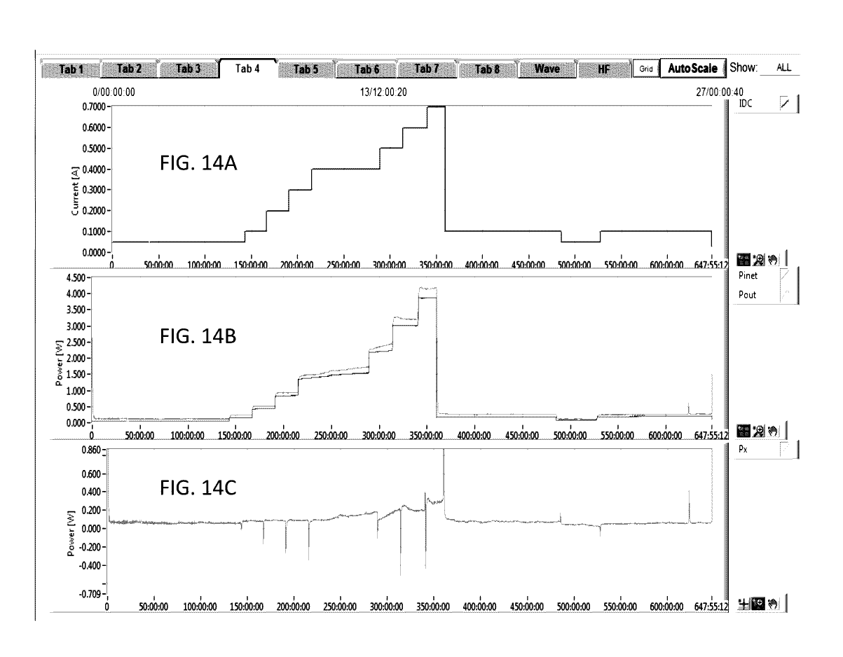

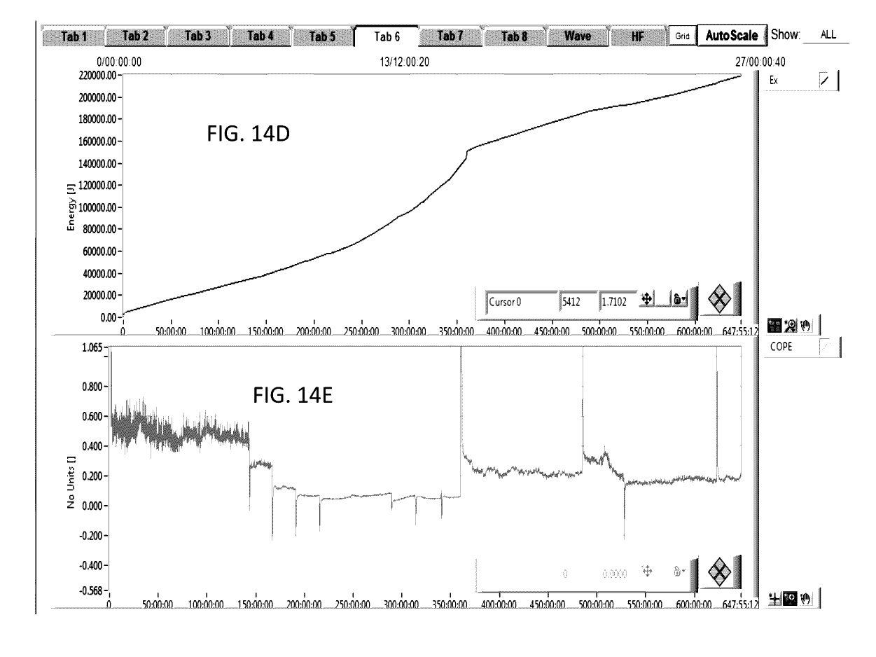

FIGS. 14A-14E are results from an electrolysis experiment for the co-deposition experiment in the presence EGCG palladium nanoparticles in D₂O and 0.1M LiOD, with the same electrolyte as in Experiment 1039.

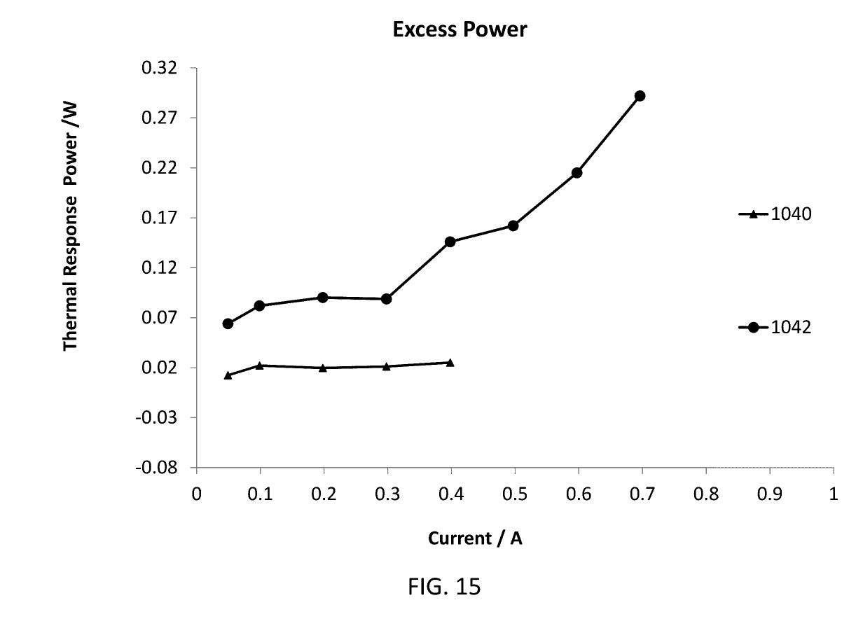

During first 140 hours of the experiment at net input power of 0.05 W, the cell showed little thermal response power of 0.064 W. When the net input power was increased to 3.8 W, the thermal response increased up to 0.29 W. However when the input power was dropped back to 0.05 W the thermal response dropped back to ˜0.044 W. FIGS. 14D-14E show total thermal response energy of 220 kJ for 27 days of electrolysis. COP of the cell was ˜50% at low applied current and decreased by increasing current and time. FIG. 15 show that thermal response power is created with the co-deposition provided via the EGCG nanoparticles.

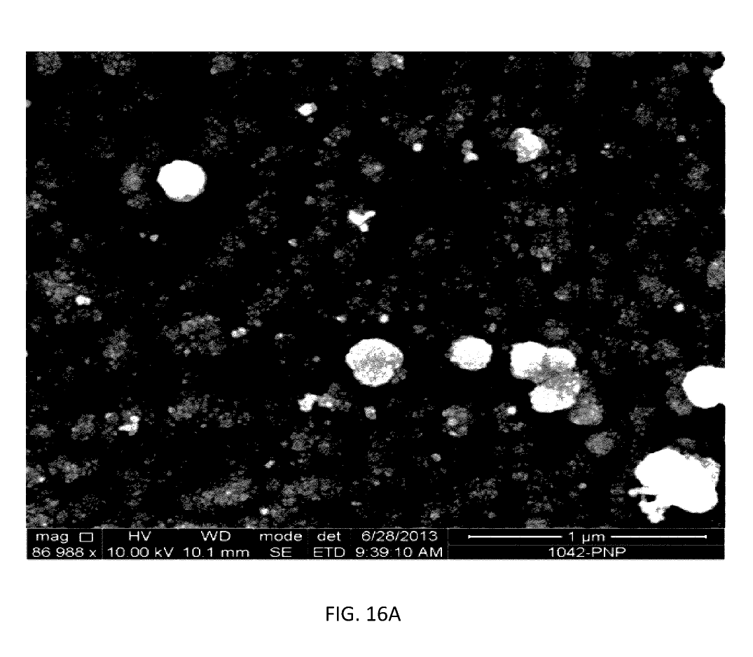

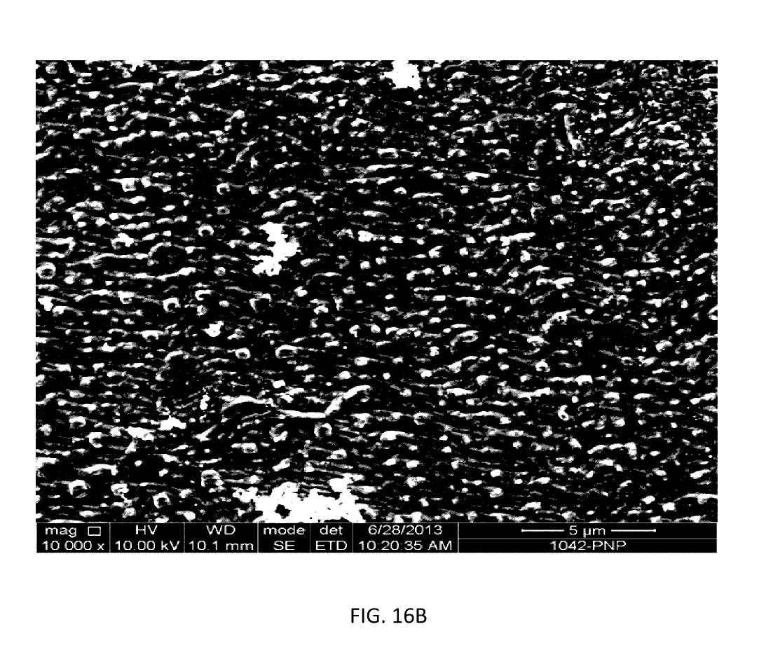

FIGS. 16A and 16B show the deposit layer of Pd nanoparticles from EGCG palladium nanoparticles in D₂O on Pd substrate in the presence of 0.1M LiOD by direct current density of 6-83 mA/cm² for 26 days. The images show highly developed surfaces with micro and nano structures. While not bound by this theory and the explanation not being necessary to practice the invention, this morphology is believed to be important to excite the generation of excess heat that has been demonstrated experimentally.

EGCG Palladium Nanoparticles D₂O and LiOD (EXP 1056)

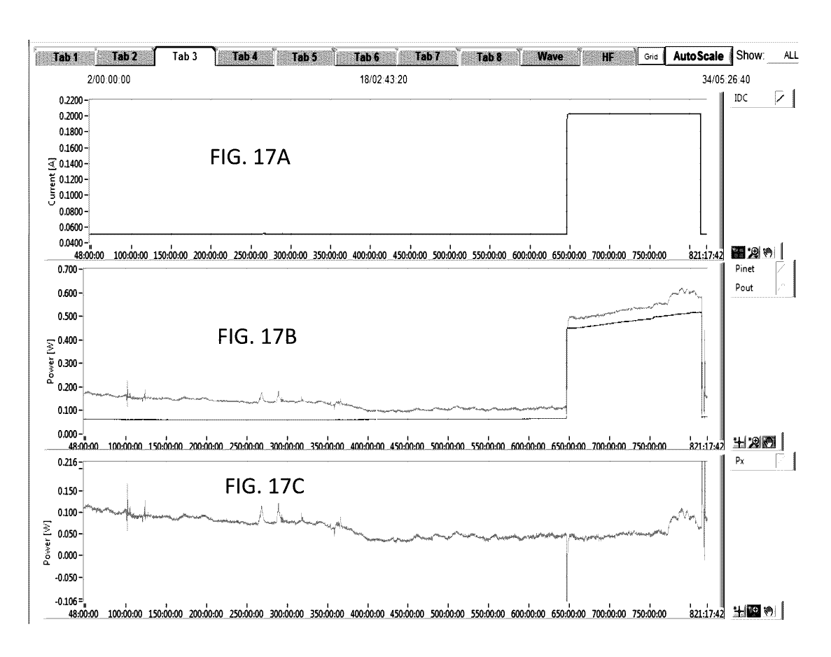

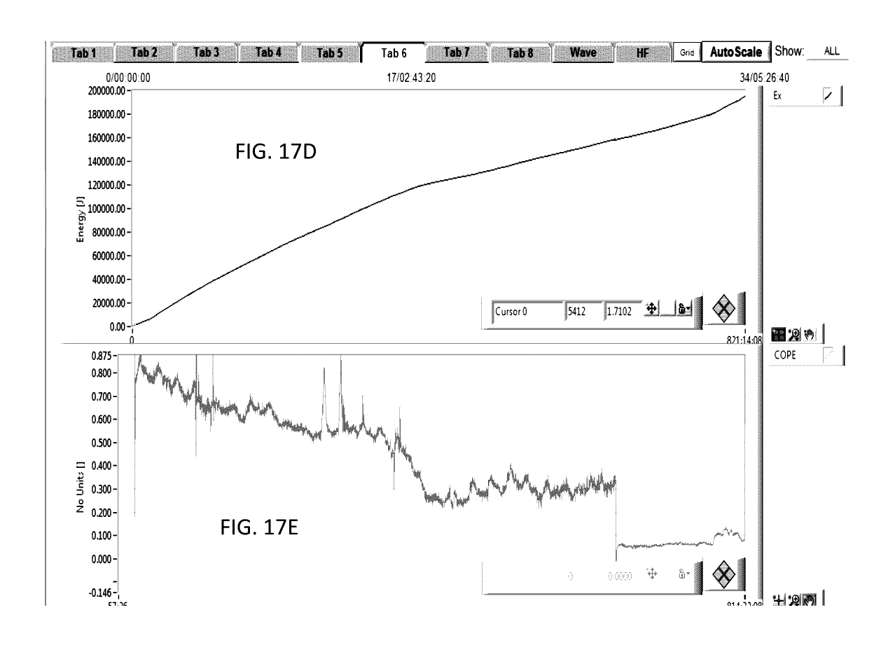

FIGS. 17A-17E are results for a 34 day period of co-deposition experiment in the presence of EGCG palladium nanoparticles in D₂O and 0.1M LiOD (Experiment 1056). The data show ˜0.1 W of thermal response power at an average net input power of 0.06 W and current of ˜50 mA for more than 150 hours. The thermal response power gradually decreased to 0.05 W by time at constant net input power of 0.06 W. This plot also shows that by increasing the current to 200 mA the thermal response power remains constant at about 0.05 W. FIGS. 17D and 17E show total thermal response energy of 200 kJ for 34 days of electrolysis, and that COP of the cell was ˜80% at low applied current and decreased by increasing current and time.

EGCG Palladium Nanoparticles in D₂O (EXP 1080)

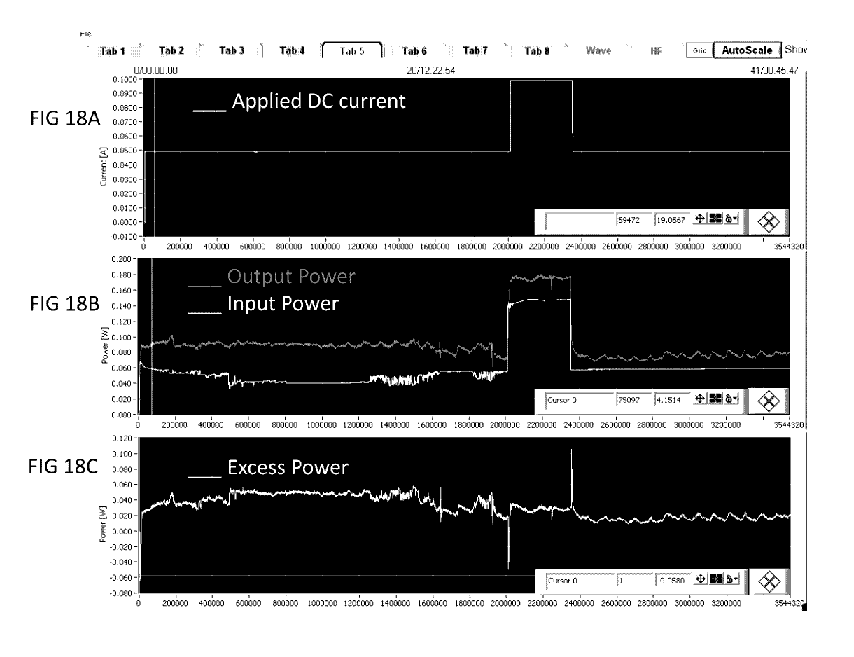

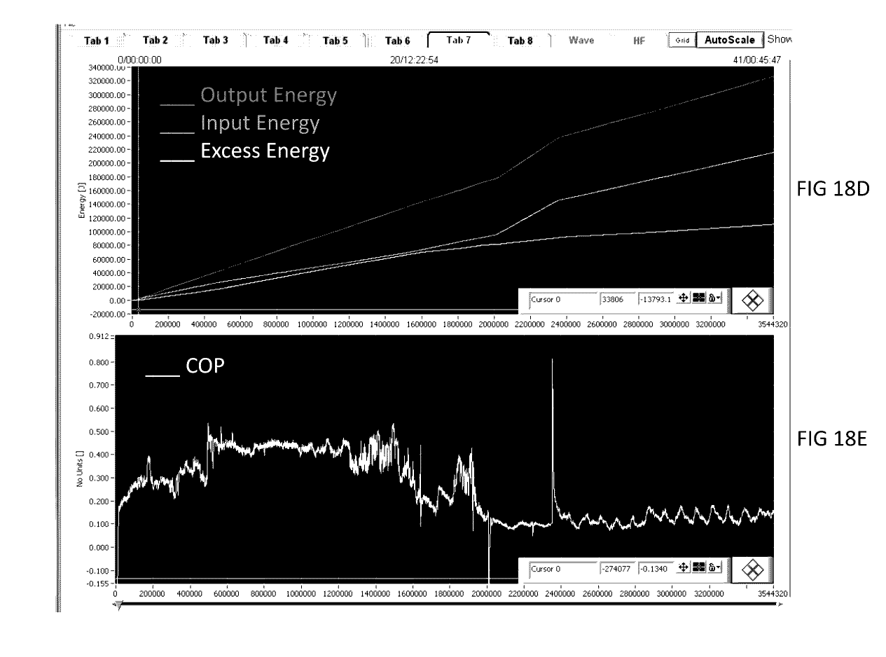

FIGS. 18A-E are results from a 41 day period of co-deposition experiment in the presence of EGCG palladium nanoparticles in D₂O and 0.1M LiOD (EXP 1080). The results measured ˜0.07-0.09 W of thermal response (Pₒᵤₜ) at an average net input power of 0.02-0.05 W (applied current of ˜50 mA). This plot also shows that by increasing the current to 100 mA the excess thermal response power (Pₓ=Pₒᵤₜ−Pᵢₙₑₜ) remains constant at about 0.02 W. FIGS. 18 D and 18E show total excess thermal response (Eₓ) energy of 1100 kJ for 41 days of electrolysis, and that COP of the cell was ˜45% at low applied current and decreased by time.

EGCG Palladium Nanoparticles in D₂O (EXP 1085)

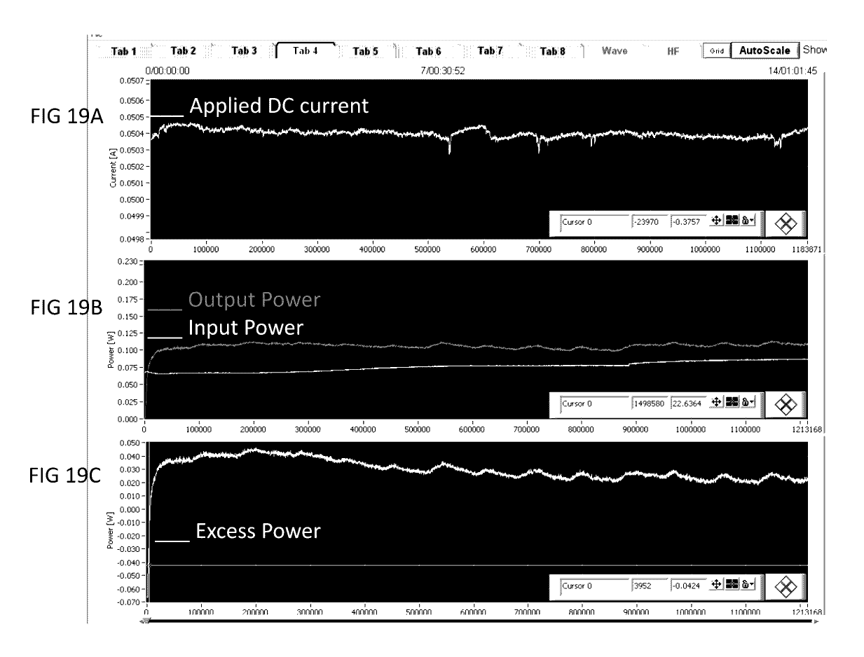

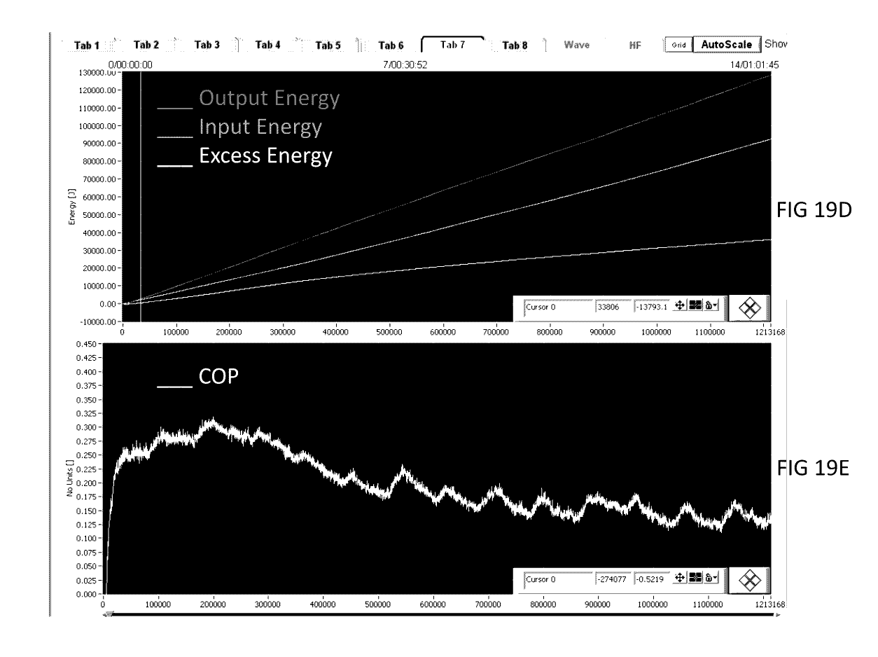

FIGS. 19 A-E are results from a 14 day period of co-deposition experiment in the presence of EGCG palladium nanoparticles in D₂O and 0.1M LiOD (EXP 1085). The results measured ˜0.11 W of thermal response (Pₒᵤₜ) at an average net input power of 0.075 W (applied current of ˜50 mA). FIGS. 19D and 19E show total thermal response energy of 35 kJ for 14 days of electrolysis, and that COP of the cell was ˜30% at low applied current and decreased by time.

Pd Nanoparticle Deposition on Pd Foil

Electrochemistry provides for deposition of metallic nanoparticles and for electrode surface modification. Deposition of metallic nanoparticle with uniform size on the surface of conductive substrate requires strong metallic nanoparticle attachment.

An electrophoretic deposition (EPD) technique was used in the experiments to deposit Pd nanoparticles with good mechanical and chemical properties directly on a variety of substrates, such as Pd foil and Pd+SWCNTs from different PdNP suspensions as an electrolyte.

The particles were deposited by direct current (DC) EPD to take advantage of the charging method to obtain uniform Pd nanoparticles on the surface of substrate with minimum aggregation and to avoid losing important properties achieved at nano-level. Pulse current (PC), pulse reverse current (PRC) and Highly Modulated current also can be applied.

Electrodeposition Technique:

Electrophoretic deposition was carried out at ambient temperature with a 25 ml of solution containing different concentration of Pd nanoparticles (X) with various type of PdNP suspension, in a glass cell.

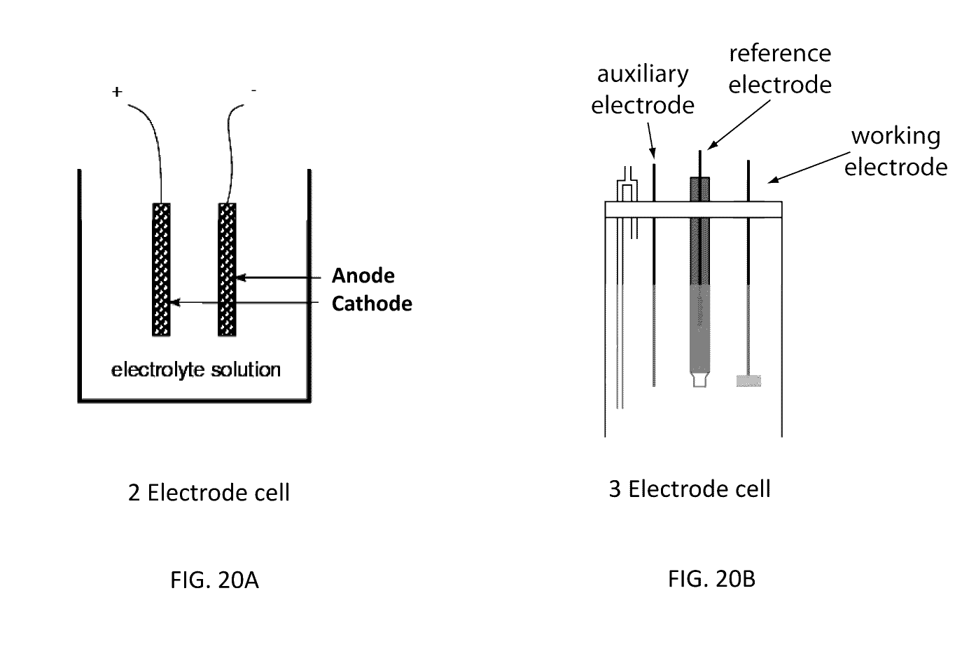

Electrochemical deposition of Pd nanoparticle was carried out in two electrode (FIG. 20A) and three electrode cells (FIG. 20B). The cell configuration is conventional, but the cells use an electrolyte solution of EGCG palladium nanoparticles. A Pd foil and a Pt sheet were used as the cathode and anode, respectively in a two electrode cell. A Pd foil, a Pt sheet and saturated Ag/AgCl electrode were used as the working, counter and reference electrode respectively in a three electrode cell. The spacing between the electrodes was 1 cm, and the geometric surface area of the Pd foil substrate for the deposition of Pd nanoparticles was 4 cm². During electrophoretic deposition, the solution color gradually turned from dark brown to clear. The time required for the complete deposition of Pd nanoparticles onto the Pd substrate decreased with increasing the electric field strength (current density) or decreasing the total concentration of Pd nanoparticles.

Substrate Preparation:

A Pd foil with 50 μm thickness with a purity of about 99.99% of Alfa Aesar and an area of about 4 cm² was used as a cathode. To remove oil trace from its surface, the substrate was etched in concentrated nitric acid (HNO₃) for about 10 minutes.

Electrolyte:

Palladium nanoparticle (PdNP) suspension in (2R,3R)-5,7-dihydroxy-2-(3,4,5-trihydroxyphenyl)-3,4-dihydro-2H-1-benzopyran-3-yl 3,4,5-trihydroxybenzoate (EGCG). Conductivity adjustment has been done by adding LiOH/LiOD.

1×=PdNP concentration in the suspension

5×=PdNP concentration which is five times higher than 1×PdNP suspension

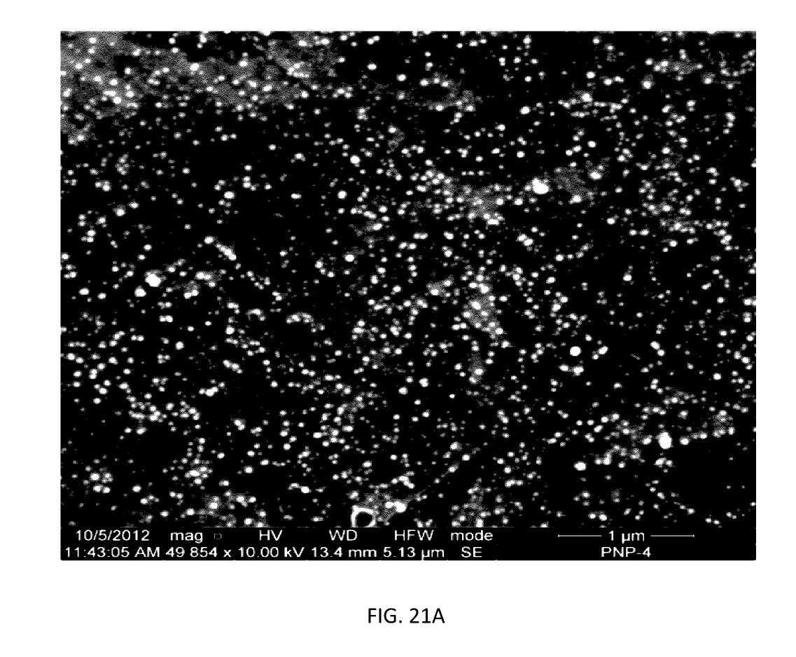

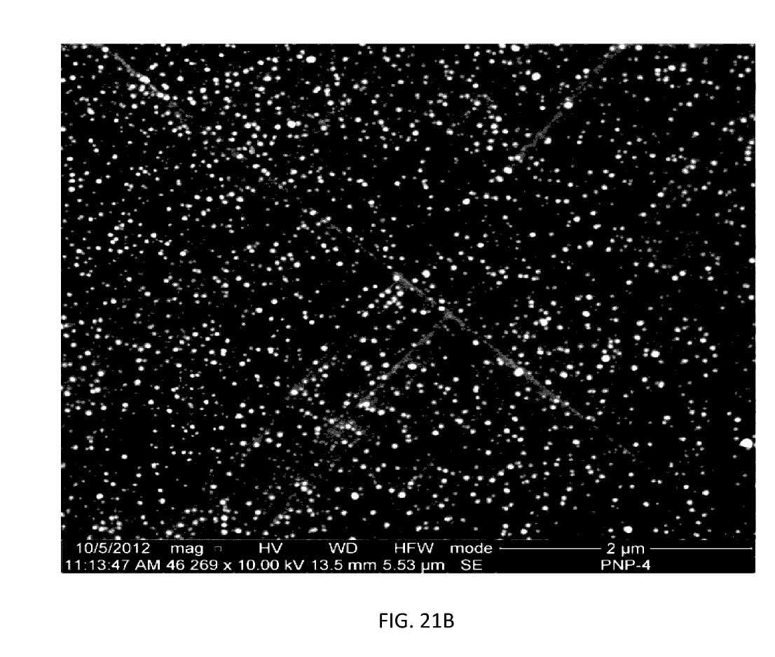

FIGS. 21A and 21B show the deposit layer of Pd from EGCG palladium nanoparticles in H₂O on Pd substrate in the presence of 0.1M LiOH by direct current of 3 mA/cm² for 20 min. The SEM image shows that the surface of Pd foil is covered with individual particles in nanosize. The number of aggregated particles in the deposit is very low.

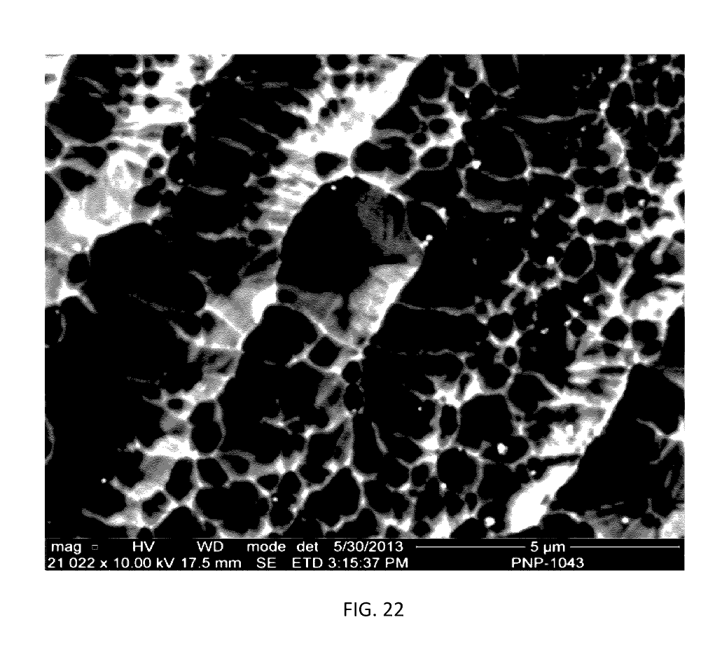

FIG. 22 shows a deposit layer of Pd from EGCG palladium nanoparticles in H₂O on Pd substrate in the presence of 0.1M LiOH by direct current of 5 mA/cm² for 15 min. In this case, before PdNp deposition the Pd foil was etched in HNO₃ and aqua regia for 1 min. The surface treatment produces a different deposition. Comparison to FIGS. 21A and 21B shows that the surface structure is completely different from previous experiment in the same electrolyte but different electrochemical and surface condition. FIG. 22 show a cell like structure on the surface of etched Pd foil.

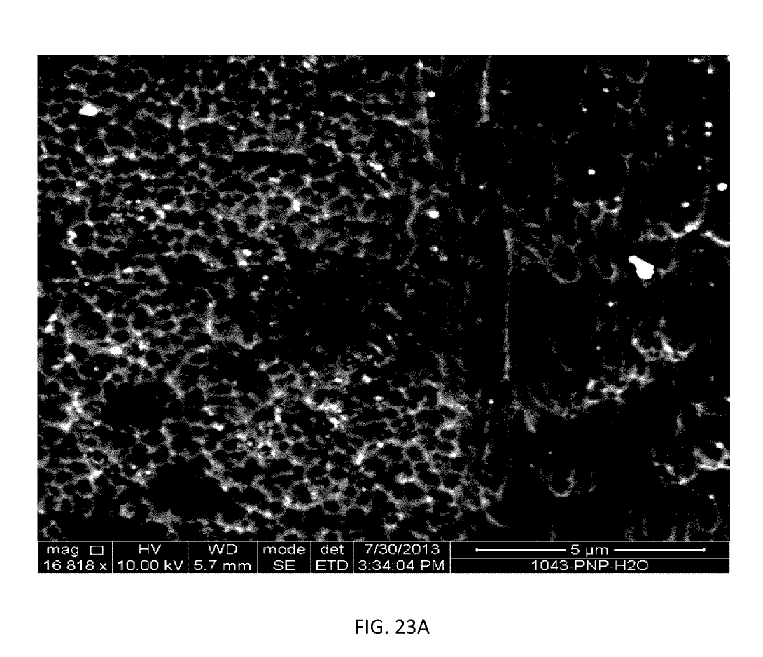

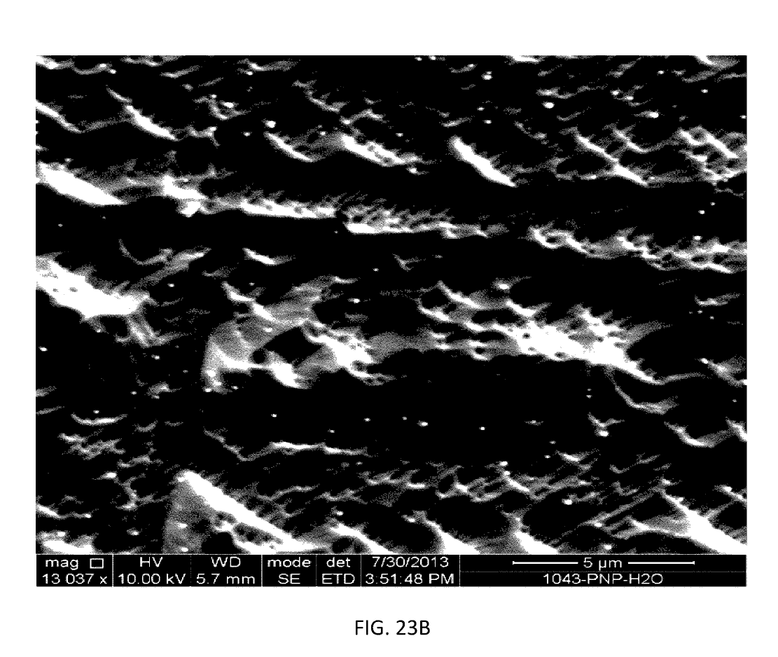

FIGS. 23A and 23B-shows the surface structure of Pd foil modified with Pd nanoparticles after electrolysis in pure 0.1M LiOH for more than 20 days under direct current of 5-10 mA/cm². SEM images show novel structure with fewer cells like structure, smoother surface and two to three different orientations.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. An environmentally friendly method for making epigallocatechin Gallate (EGCG) stabilized palladium nanoparticles, the method comprising:
mixing a solution of epigallocatechin Gallate (EGCG) as a reducing agent with an aqueous solution containing palladium salts;
permitting reaction of the palladium salts, in the absence of any other reducing agent, to form stabilized EGCG coated palladium nanoparticles.

2. The method of claim 1, wherein the solution containing palladium salts comprises sodium tetra choloropalladate.

3. The method of claim 2, wherein the solution of EGCG comprises distilled water.

4. The method of claim 3, wherein the solution of palladium salts comprises carrier NaAuCl₄ solution.

5. The method of claim 1, wherein the solution containing palladium salts comprises heavy water.

6. The method of claim 5, wherein said mixing and reacting are performed with little or no exposure to light.

7. The method of claim 6, wherein said mixing and reacting are performed in an environment without oxygen.

8. The method of claim 7, wherein said mixing and reacting are performed in a nitrogen environment.

9. The method of claim 8, wherein the solution containing palladium salts comprises sodium tetra choloropalladate.

10. An electrochemical cell, comprising:
a cell containing a substrate or foil cathode and at least one anode spaced apart from each other;
an electrolyte solution comprising EGCG palladium nanoparticles;
a power source to create potential between said cathode and said at least one anode.

11. The cell of claim 10, further comprising a conductivity adjuster in said electrolyte solution.

12. The cell of claim 10, wherein the electrolyte comprises (2R,3R)-5,7-dihydroxy-2-(3,4,5-trihydroxyphenyl)-3,4-dihydro-2H-1-benzopyran-3-yl 3,4,5-trihydroxybenzoate (EGCG).

13. The cell of claim 10, wherein the electrolyte comprises heavy water.

14. An electrochemical energy converter, the converter comprising:
an electrochemical cell of claim 10; and
a heat transfer outlet to remove heat generated from the cell containing the substrate or foil.

15. The converter of claim 14, wherein the power source causes deposition of EGCG palladium nanoparticles and the heat generated is a net energy gain compared to the electrical power provided by the power source.

16. A method for electrophoretic deposition of palladium nanoparticles onto a surface, the method comprising:
spacing a metal foil cathode and at least one anode apart from each other;
immersing the cathode and anode in electrolyte containing EGCG palladium nanoparticles;
applying direct current to the cathode and anode.

17. A biologically compatible nanoparticle consisting of palladium coated with EGCG.
